(19) United States
(12) Patent Application Publication
(10) Pub. No.: US 2023/0415710 A1
(43) Pub. Date: Dec. 28, 2023

(54) Stabilizer for a Multi-Axle Vehicle

(71) Applicant: ETN Capital, LLC, Stanford, NC (US)

(72) Inventors: Ryan Beaver, Richmond, VA (US); William Myles Riley, Richmond, VA (US)

(21) Appl. No.: 17/850,001

(22) Filed: Jun. 27, 2022

(51) Int. Cl. B60S 9/04

(52) U.S. Cl. CPC B60S 9/04

(57) ABSTRACT

A stabilizer to stabilize wheels of a parked multi-axle vehicle. The stabilizer is selectively movable between a retracted orientation sized to fit within a space formed between the wheels of the vehicle. In the retracted orientation the stabilizer is spaced away from the wheels. The stabilizer is deployed to an extended orientation that contacts against the wheels. The stabilizer prevents the wheels from rotating thus providing stability to the vehicle and preventing movement along the ground.

### TECHNICAL FIELD

The present application relates generally to devices to stabilize wheels of a multi-axle vehicle and, more specifically, to stabilizers configured to slide between extended and retracted orientations.

### BACKGROUND

Devices are used to prevent rotation of the wheels of a multi-axle vehicle. In one example, the devices are used on recreational vehicles (RV) such as campers and trailers. Engaging the wheels prevents forwards and backwards motion of the vehicle when the vehicle is parked (such as at a camping site). This forward and backward motion is particularly an issue when people are moving about inside of the vehicle.

Existing devices utilize a mechanism that is movable into engagement with the wheels through rotation of a lead screw. An issue with lead screws is the relatively large number of rotations needed to move the device into engagement with the wheels. This can be a cumbersome activity that is time consuming to the user. Further, it can require the user to hold the device in position near the wheels while simultaneously rotating the lead screw. This can be a physically difficult process for many people. Likewise, the device is difficult to collapse and disengage from the wheels as the lead screw is not able to be quickly reduced in size. The process of engaging and disengaging the wheels with a lead screw device can be further complicated as the process is usually performed outside in various weather conditions which can make this strenuous process even more difficult.

Existing devices also apply a relatively large amount of force to the wheels. This force can be far greater than what is necessary to secure the wheels to prevent the forward and backward movement of the vehicle. Thus, the user is required to perform rotations of the lead screw to simply apply a relatively large force that is not required.

Many existing devices are relatively large with large lead screws and engagement members that contact the wheels. The relatively large size makes the devices difficult to store when not in use. For example, a device that is used with an RV may be stored in the vehicle when not in use. The large size makes storage difficult as there is limited space in an RV and the existing space may not be adequate to house the device when not in use.

### SUMMARY

One aspect is directed to a stabilizer to stabilize wheels on a multi-axle vehicle. The stabilizer comprises a working bar comprising opposing first and second ends and with a longitudinal axis that extends along a length. A linkage assembly is connected to the working bar and comprises arms that are pivotally connected together and movable between a retracted orientation with a first width measured perpendicular to the longitudinal axis and an extended orientation with a larger second width measured perpendicular to the longitudinal axis. An actuator is mounted to the working bar and to the linkage assembly. The actuator comprises a first plate with a first opening that receives the working bar and a second plate with a second opening that receives the working bar. The first plate and the second plate are movable relative to each other between a first angular position to prevent movement of the actuator along the length of the working bar and secure the linkage assembly and a second angular position to provide for movement along the length of the working bar to move the linkage assembly between the retracted orientation and the extended orientation.

In another aspect, a biasing member biases the first plate and the second plate towards the first angular position to prevent movement of the actuator along the length of the working bar.

In another example, the linkage assembly is fixedly connected to the working bar at a first point along the longitudinal axis with the first point being spaced away from the actuator.

In another example, the linkage assembly is fixedly connected to the working bar at a single point.

In another example, the linkage assembly comprises a first linkage positioned on a first side of the working bar and a second linkage positioned on an opposing second side of the working bar with the first and second linkages aligned in planes that are parallel.

In another example, cylindrical contact members are mounted at the outer edges of the linkage assembly with the contact members configured to contact against the wheels of the multi-axle vehicle.

In another example, the actuator further comprises a body with a handle and a lever arm pivotally connected to the body, with the first plate mounted to the body away from the handle and the lever arm and the second plate mounted in the lever arm.

In another example, the body comprises a body opening that is aligned with the first opening of the first plate and the second opening of the second plate with the working bar extending through the actuator at each of the opening, the first opening, and the second opening.

In another example, the linkage assembly comprises a first end and a second end with the first end fixedly connected to the working bar and the actuator mounted to the second end.

One aspect is directed to a stabilizer to stabilize wheels on a multi-axle vehicle. The stabilizer comprises an elongated working bar, a linkage assembly connected to the working bar and comprising arms that pivotally connect together and are movable between a retracted orientation and an extended orientation and an actuator mounted to the working bar and to the linkage assembly and configured to move the linkage assembly between the retracted and extended orientations. The actuator comprises a body with a body opening, a first plate mounted to the body and with a first plate that comprises a first plate opening, a second plate mounted to the body and with a second plate that comprises a second plate opening. The body opening, first plate opening, and second plate opening are aligned and with the working bar extending through each. The first plate and the second plate movable relative to each other between a first angular position to prevent movement of the actuator along the working bar and secure the linkage assembly and a second angular position to provide for movement along the length of the working bar to move the linkage assembly between the retracted orientation and the extended orientation.

In another aspect, the first plate and the second plate are aligning in a non-parallel arrangement in the first angular position and a parallel arrangement in the second angular position.

In another aspect, the first plate and the second plate are each perpendicular to the working bar in the second angular position.

In another aspect, the actuator further comprises a lever arm pivotally mounted to the body and with one of the first plate and the second plate mounted to the lever arm.

In another aspect, each of the first plate and the second plate are movable relative to the body.

In another example, the first plate is spaced apart from the second plate along the working bar.

One aspect is directed to a method of stabilizing wheels of a multi-axle vehicle. The method comprises: positioning a stabilizer that is in a retracted orientation in a space formed between the wheels of the multi-axle vehicle; orienting the stabilizer in the space with a working bar aligned vertically in the space and with contact members facing towards the wheels; applying a force to an actuator on the working bar and positioning plates in the actuator at a first angular orientation; with the plates in the first angular orientation, sliding the actuator along the working bar and causing the contact members to move outward from the working bar and contact against the wheels; and with the contact members contacting against the wheels, releasing the force from the actuator and thereby positioning the plates in the handle at a second angular orientation and preventing the contact members from moving out of contact with the wheels.

In another aspect, the method further comprises sliding the actuator along the working bar and expanding a width of a linkage assembly by sliding a bottom of a linkage assembly that is connected to the actuator towards a top of the linkage assembly that is fixedly connected to the working bar.

In another aspect, the method further comprises contacting four of the contact members against the wheels with a first pair of the contact members mounted to a first pair of arms and a second pair of the contact members mounted to a second pair of the arms.

In another aspect, the method further comprises maintaining a bottom of the working bar above a ground surface that supports the wheels while sliding the actuator along the working bar.

In another aspect, the method further comprises sliding the actuator along the working bar without rotating the actuator or the working bar.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic side view of a stabilizer contacting against the wheels of a vehicle.

FIG. 2A and FIG. 2B are schematic diagrams of the stabilizer in different orientations.

FIG. 3 is a perspective view of a stabilizer in a first orientation.

FIG. 4 is a perspective view of the stabilizer of FIG. 3 in a second orientation.

FIG. 5 is a schematic side view of the stabilizer illustrating a plane that extends through the working bar.

FIG. 6A is a section view of a stabilizer with an actuator in a locked configuration.

FIG. 6B is a section view of the stabilizer of FIG. 5A in an unlocked configuration.

FIG. 7A is a schematic top view of a working bar extending through an opening in one of the plates.

FIG. 7B is a schematic top view of a working bar extending through an opening in one of the plates.

FIG. 8 is a flowchart diagram of a method of stabilizing wheels of a multi-axle vehicle.

### DETAILED DESCRIPTION

The present application is directed to a stabilizer 10 to stabilize wheels 101 of a parked multi-axle vehicle 100. The stabilizer 10 is selectively movable between a retracted orientation sized to fit within a space 102 formed between the wheels 101 of the vehicle 100. In the retracted orientation the stabilizer 10 is spaced away from the wheels 101. The stabilizer 10 is deployed to an extended orientation that contacts against the wheels 101. The stabilizer 10 prevents the wheels 101 from rotating thus providing stability to the vehicle 100 and preventing movement along the ground 200.

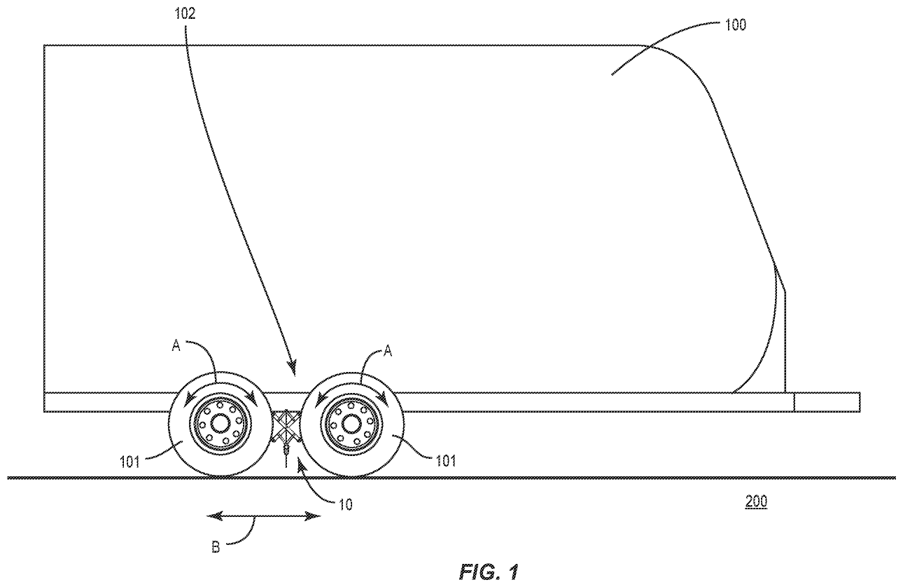

FIG. 1 illustrates a stabilizer 10 positioned in the space 102 formed between the wheels 101 of the vehicle 100. The stabilizer 10 is in a deployed orientation contacting against the wheels 101. This contact prevents the wheels 101 from rotating about their axles as shown by arrows A. The stabilizer 10 prevents the vehicle 100 from moving in forward and backward directions shown by arrow B along the ground 200. In one example as illustrated in FIG. 1, the stabilizer 10 is positioned in the space 102 and just contacts against the wheels 101 but does not contact against any other section of the vehicle 100. The stabilizer 10 can also be positioned above the ground 200 when engaged with the wheels 101. In another example, the stabilizer 10 contacts against another section of the vehicle 100 in addition to the wheels 101.

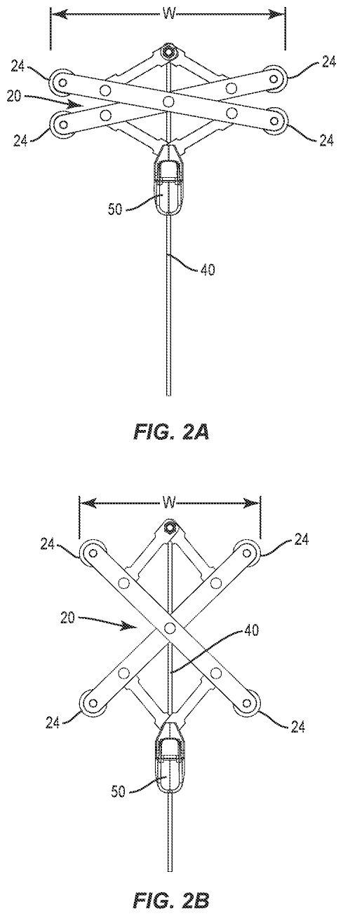

FIGS. 2A and 2B schematically illustrate the stabilizer 10 in the different orientations. FIG. 2A illustrates the stabilizer 10 in a retracted orientation having a width W measured between the contact members 24 on the opposing outer lateral sections. The width W in the retracted orientation is smaller than the space 102 formed between the wheels 101. This reduced size provides for positioning the stabilizer 10 between the wheels 101. FIG. 2B illustrates the stabilizer 10 in an extended orientation. The width W measured between the opposing contact members 24 is larger thus providing for the contact members 24 to contact against the wheels 101. The stabilizer 10 can be secured in the extended orientation to maintain the position in contact with and prevent rotation of the wheels 101. The stabilizer 10 is adjustable such that the width W can vary in the retracted and extended orientations depending upon the size of the space 102. This adjustability provides for the stabilizer 10 to be used on different vehicles 100.

The stabilizer 10 includes a linkage assembly 20 having an X-shape. The stabilizer 10 functions to prevent one wheel 101 of a first axle from rotating relative to the matching wheel 101 on the second axle. The X-shape linkage assembly 20 prevents the rotation because when one wheel 101 rotates a first direction (e.g., clockwise), the contact of the X shape linkage assembly 20 attempts to rotate the second wheel 101 in the opposing second direction (e.g., counterclockwise). This is prevented due to the engagement of the stabilizer 10 in combination with the weight of the vehicle 100 and friction between the wheels 101 and the ground 200. This prevents forwards and backwards motion of the vehicle 100 when parked and people are moving about inside of the vehicle 100.

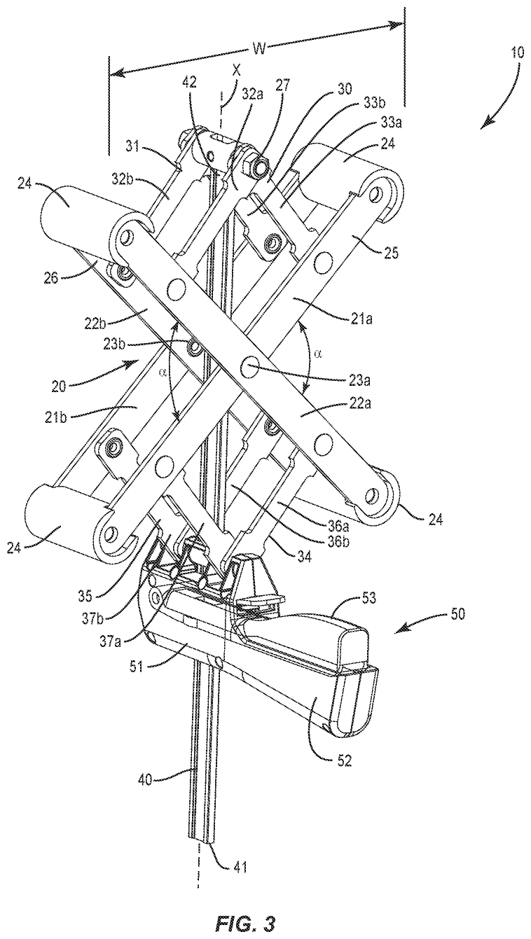

FIG. 3 illustrates the stabilizer 10 that includes a linkage assembly 20, a working bar 40, and an actuator 50. The linkage assembly 20 and the actuator 50 move relative to the working bar 40 between the retracted and deployed orientations. The stabilizer 10 moves between retracted and extended orientations by the actuator 50 sliding along the length of the working bar 40 and adjusting the linkage assembly 20. The stabilizer 10 does not include threaded members and does not require rotation of a screw or other like threaded device to provide for adjustment of the size.

The linkage assembly 20 includes a X shape formed by paired elements on opposing sides of the working bar 40. The paired elements include a first X linkage 25 positioned on a first side of the working bar 40 and the second linkage 26 positioned on an opposing second side of the working bar 40. The first linkage 25 includes arms 21a, 22a that are pivotally connected at a connector 23a. The second linkage 26 includes arms 21b, 22b that are pivotally connected at connector 23b. The first and second linkages 25, 26 mirror each other during the movements between the retracted and deployed orientations.

Contact members 24 extend between the outer ends of the linkages 25, 26. Specifically, the contact members 24 are positioned between the ends of the arms 21a, 21b, 22a, 22b. The contact members 24 are positioned to contact against the wheels 101. In one example as illustrated in FIG. 3, the contact members 24 have a circular sectional shape. Other examples include the contact members 24 with other, non-circular sectional shapes. The contact members 24 can be secured to prevent rotation upon contact with the wheels 101. In one example as illustrated in FIG. 3, the contact members 24 have a substantially cylindrical shape with cut-outs at each end to receives the arms 21a, 21b, 22a, 22b. The cut-outs and arms 21a, 21b, 22a, 22b prevent rotation of the contact members 24.

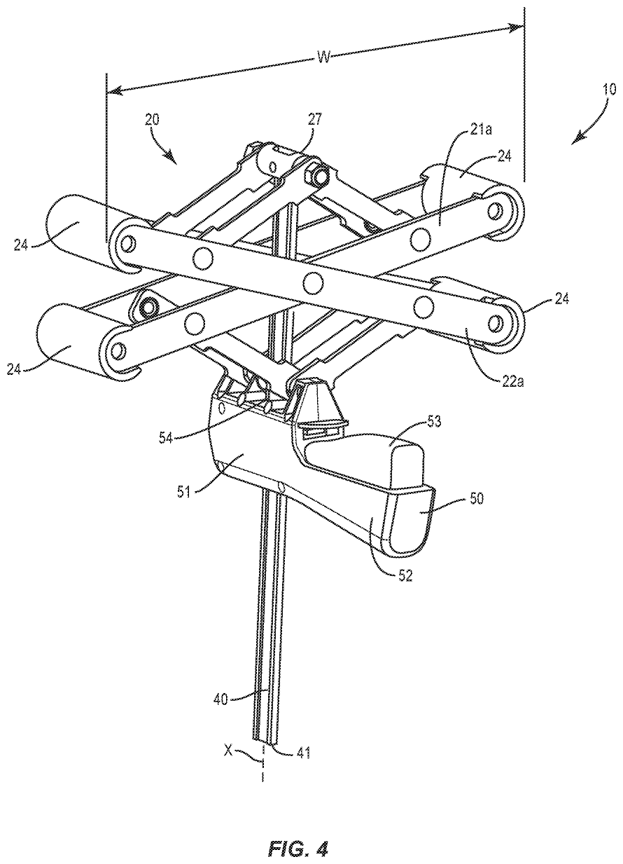

The stabilizer 10 functions by exerting a pressure on the wheels 101. The pressure on each of the wheels 101 is equal to the total force from the stabilizer 10, divided by four to account for each of the four contact members 24, divided by the surface area of each contact member 24. Adjustment of the surface area of the contact members 24 provides for adjustment of the amount of pressure applied to the wheels 101. For example, halving the surface area of a contact member 24 effectively doubles the pressure applied by the contact member 24 (for the same amount of force from the stabilizer 10). In the example illustrated in FIGS. 3 and 4, the surface area of the contact members 24 is reduced by using a circular shape (convex in comparison to the wheel 101). The circular shape creates a very small contact patch as the contact members 24 initially contacts against the wheel 101 during deployment. As the stabilizer 10 is further deployed, the contact members 24 are forced into the wheels 101 which deform and the surface area of contact increases (as the wheel deforms to form around the contact member).

The linkage assembly 20 also includes mounting linkages 30, 31. Mounting linkage 30 is positioned on the first side of the working bar 40 and includes arms 32a, 33a. Mounting linkage 31 is positioned on the second side and includes arms 32b, 33b. First ends of the arms 32a, 32b 33a, 33b are fixedly mounted to the working bar 40. The first ends do not move vertically along the working bar 40 during movement between the retracted and extended orientations. In one example, a connector 27, such as a bolt secures the first ends to the working bar 40. The second ends of the arms 32a, 32b, 33a, 33b are connected to intermediate sections of the arms 21a, 21b, 22a, 22b.

A second pair of mounting linkages 34, 35 extend between the arms 21a, 21b, 22a, 22b and the actuator 50. Mounting linkage 34 includes arms 36a, 37a and is positioned on the first side of the working bar 40. Mounting linkage 35 includes arms 36b, 37b and is positioned on the second side. Arms 36a, 36b, 37a, 37b. The mounting linkages 34, 35 are connected to the actuator 50 and move along the length of the working bar 40 during movement of the stabilizer 10 between the retracted and extended orientations.

As illustrated in FIG. 3, angles α are formed between the arms 21a, 22a. Corresponding angles (not labeled in FIG. 3) are likewise formed between the arms 21b, 22b. FIG. 3 illustrates the stabilizer 10 in a first orientation with the angles α being a first amount. This positioning includes the actuator 50 positioned a first distance away from the upper end of the linkage assembly 20 (i.e., away from the connector 27). FIG. 4 illustrates the stabilizer 10 in an extended orientation with the actuator slid along the working bar 40 into closer proximity to the upper end of the linkage assembly 20. The angles α are smaller as the arms 21a, 21b, 22a, 22b are pivoted with the contact members 24 positioned farther outward from the working bar 40 to contact against the wheels 101. The change in positioning of the location of the actuator 50 along the working bar 40 causes the arms 21a, 21b, 22a, 22b to pivot and the width W measured between opposing contact members 24 to increase and thus for the contact members 24 to engage with the wheels 101.

The stabilizer 10 can be positioned at various orientations with various arm angles α in the retracted and extended orientations. The retracted orientation includes arm angles α that provide for the stabilizer 10 to be positioned in the space 102 and located away from the wheels 101. The extended orientation includes arm angles α for the contact members 24 to engage with the wheels 101. The exact arm angles α will vary depending upon the size of the space 102, positioned of the wheels 101, etc.

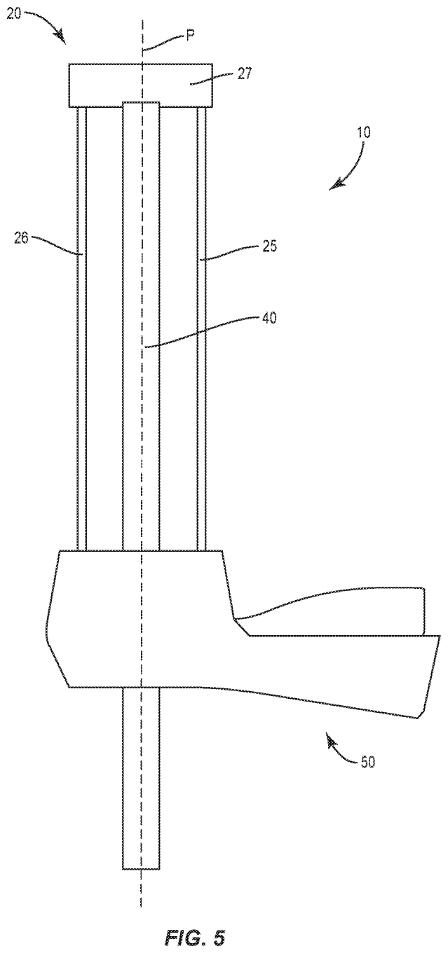

The linkage assembly 20 is symmetrical about a first plane that extends through a longitudinal axis X of the working bar 40. As illustrated in FIGS. 3 and 4, the connectors 23a, 23b and 27 are positioned on the longitudinal axis X. In one example, the actuator 50 is connected to the working bar 40 along the longitudinal axis X. The linkage assembly 20 is also symmetrical about a second plane P that extends through the working bar 40 as illustrated in FIG. 5. The plane P divides the first and second linkages 25, 26, the mounting links 30, 31, and the mounting links 34, 35. In one example, the first and second planes are perpendicular. In another example, the planes are not perpendicular.

In one example the stabilizer 10 is identical on opposing sides of the second plane P. This includes the first and second linkages 25, 26 being identical, the mounting links 30, 31 being identical, and the mounting links 34, 35 being identical. In other examples, one or more of these elements are different on the opposing sides of the second plane P.

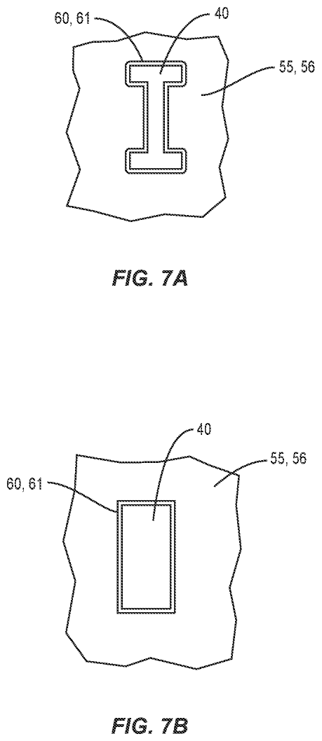

The working bar 40 is a rigid member with an elongated shape that extends between opposing ends 41, 42. The length of the working bar 40 measured between the ends 41, 42 can vary depending upon the size of the vehicle 100. In one example, the working bar 40 includes a straight shape that facilitates movement of the actuator 50 along the length. In another example, the working bar 40 has a curved shape. The sectional shape of the working bar 40 can vary, with examples including but not limited to an I-shape as illustrated in FIG. 7A and a rectangular shape as illustrated in FIG. 7B. The working bar 40 is fixedly connected to the linkage assembly 20 and is movably connected to the actuator In one example, the linkage assembly 20 is connected at the first end of the working bar 40.

The actuator 50 is configured to slide along the length of the working bar 40 to selectively adjust the orientation of the linkage assembly 20. The actuator 50 further engages with the working bar to secure the linkage assembly 20 in the selected orientation. The actuator 50 moves along the length of the working bar 40 without a threaded engagement and without the need for rotational engagement.

As illustrated in FIGS. 3 and 4, the actuator 50 includes a body 51 that includes a handle 52. The actuator 50 includes an opening 54 that receives the working bar 40. A lever arm 53 is pivotally attached to the body 51 and extends outward from the handle 52. The handle 52 and the lever arm 53 extend outward from the working bar 40 when the actuator 50 is engaged with the working bar 40 and are sized to be grasped by the user.

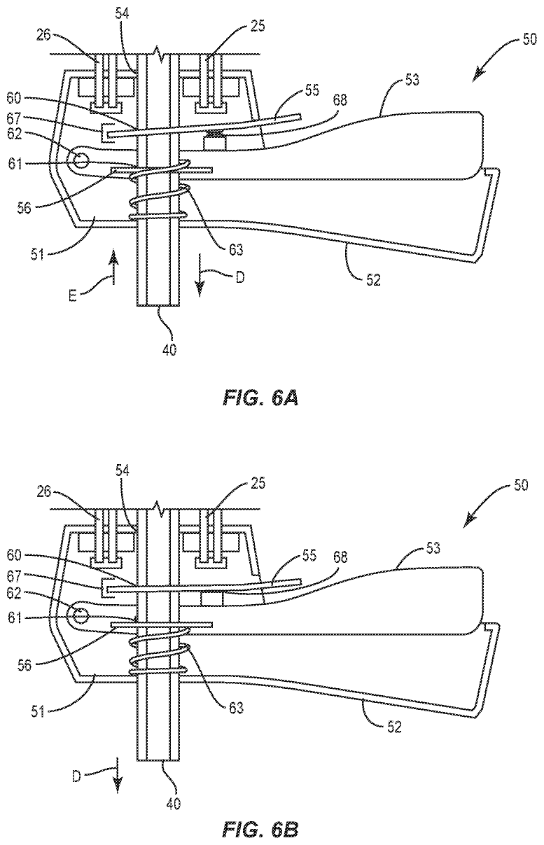

As illustrated in FIGS. 6A and 6B, the actuator 50 includes a pair of plates 55, 56. The plates 55, 56 are spaced apart along the length of the working bar 40. Each of the plates 55, 56 includes a planar section with an opening 60, 61 respectively that receives the working bar 40. The opening 54 in the body 51 and the openings 60, 61 in the plates 55, 56 are aligned within the actuator 50 to receive the working bar 40.

One or both of the plates 55, 56 can be angularly adjustable relative to each other. Plate 55 is mounted to the body 51 and biased away from the lever arm 53 with a biasing member 68. The attachment of the plate 55 to the body 51 and the biasing member 68 provide for movement of the plate Plate 56 is mounted to the lever arm 53 which is pivotally attached to the handle 52 at a pivot connection 62.

The openings 60, 61 have a shape and size that are larger than the sectional shape and size of the working bar 40. FIG. 7A illustrates one example with the working bar 40 have a substantially I-shaped cross section and the openings 60, 61 having corresponding shapes. FIG. 7B illustrates both the working bar 40 and openings 60, 61 being substantially rectangular. The larger size of the openings 60, 61 provides for the actuator 50 to be moved along the length of the working bar 40. The larger size allows for the plates 55, 56 to be positioned at different angular orientations relative to the working bar 40 for the actuator 50 to engage and disengage from the working bar 40.

The actuator 50 is biased towards an engaged position with the working bar 40. The engaged position includes the plates 55, 56 being positioned at a first angular orientation relative to each other. The first angular orientation can be maintained by the biasing member 68 that biases the plates 55, 56 apart at first angular relative orientation.

In one example when no external forces are acting on the actuator 50, the actuator 50 is in the locked orientation as illustrated in FIG. 6A. The plate 55 is biased towards the engaged position by the biasing member 68. This orientation of the plate 55 prevents the actuator 50 from moving downward along the working bar 40 in the direction of arrow D. The plate 56 is not engaged with the working bar 40.

The actuator 50 is moved upward in the direction of arrow E along the working bar 40 by the application of a force by the user. The force overcomes the force applied by the biasing member 63 and squeezes together the lever arm 53 and handle 52. This causes the plate 56 to pivot relative to the working bar 40 and for the actuator 50 to move upward in the direction of arrow E. Repeating the application and removal of force to the lever arm 53 and handle 52 can move the actuator 50 the necessary distance along the working bar 40 to deploy the linkage assembly 20 as necessary.

To disengage the actuator 50 from the working bar 40 and allow the actuator 50 to move in the direction of arrow D along the working bar 40, both plates 55, 56 are simultaneously disengaged from the working bar 40. The angular position of the plate 55 is moved by the user applying a force to the exposed end of the plate 55 towards the handle 52 as illustrated in FIG. 6B. In one example, the biasing member 63 positions the plate 56 in the disengaged position and the user is just required to move the plate 55. With the plates 55, 56 disengaged, the user applies a force to move the actuator 50 along the working bar 40 in the direction of arrow D.

In one example, the plates 55, 56 are aligned in a parallel arrangement in the unlocked position to allow for the actuator 50 to move along the length of the working bar 40 in the direction of arrow D. In one example, the plates 55, 56 are in a non-parallel arrangement in the locked position to prevent movement of the actuator 50 in the direction of arrow D. In one example in the unlocked position, each of the plates 55, 56 are perpendicular to the working bar 40, and in the locked position one or both of the plates 55, 56 are at a non-perpendicular angle relative to the working bar 40.

A block 67 is mounted at the end of the plate 55. The block 67 maintains the position of the end of the plate 55 relative to the body 51 and ensures the force from the biasing member 68 pivots the plate 55 to the locked position. The block 67 can also maintain the end of the plate 55 when a force is applied to pivot the plate 55 to the unlocked position.

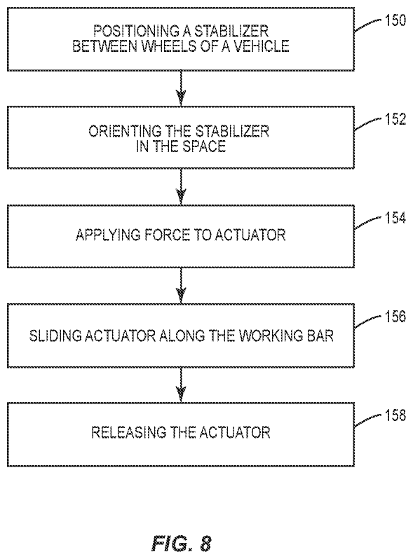

FIG. 8 illustrates a method of stabilizing the wheels 101 of a multi-axle vehicle 100. The method includes positioning a stabilizer 10 that is in a retracted orientation in a space 102 that is formed between the wheels 101 of the vehicle (block 150).

The stabilizer 10 is oriented in the space 102 with a working bar 40 aligned vertically and with contact members 24 facing towards the wheels 101 (block 152). This can include the stabilizer 10 positioned above the ground 200. This can include the stabilizer 10 positioned away from any other parts of the vehicle 100. In one example, the handle 52 of the stabilizer 10 faces outward away from the vehicle 100 to be more accessible to the user. In one example, the stabilizer 10 is orientated with the actuator 50 vertically below the linkage assembly 20. In another example, the stabilizer 10 is positioned with the actuator 50 vertically above the linkage assembly 20.

A force is applied by the user to the actuator 50 to position plates 55, 56 in the actuator 50 at a first angular orientation (block 154). In one example, the force is applied to a handle 52 and a lever arm 53 of the actuator 50. With the plates 55, 56 in the first angular orientation, the actuator 50 is slid along the working bar 40 which causes the contact members 24 to move outward from the working bar 40 and contact against the wheels 101 (block 156).

With the contact members 24 contacting against the wheels 101, the force is released from the actuator 50 which causes the plates 55, 56 to be positioned at a second angular orientation that prevents the contact members 24 from moving out of contact with the wheels 101 (block 158).

The method can include sliding the actuator 50 along the working bar 40 and sliding a bottom of the linkage assembly 20 towards a top of the linkage assembly 40. The top is connected to the working bar 40 and this movement causes lateral expansion of the linkage assembly 20.

During deployment of the stabilizer 10, the stabilizer 10 is maintained off the ground 200. This prevents the stabilizer 10 from getting dirty or full of debris which can make use more difficult.

Detachment of the stabilizer 10 from the wheels 101 can occur in a reverse order. The user applies a force to the actuator 50 which aligns the plates 55, 56 in an orientation that allows for movement of the actuator 50 along the working bar 40. This movement collapses the linkage assembly 20 which releases the wheels 101. Once collapsed to the retracted orientation, the stabilizer 10 can be removed from the space 102.

The stabilizer 10 moves between the various orientations by sliding movement of the actuator along the working bar 40. The force is applied in a linear manner to move the actuator 50 along the working bar 40. The movement does not include rotation or engagement of threaded members. In one example, the force is applied to the locking plate 55 to disengage the actuator 50.

An advantage of the stabilizer 10 over prior art designs is the actuator 50 can quickly slide along the working bar 40 while the actuator 50 is engaged by the user. In one example, this actuator 50 includes the first plate 55 depressed and held in its non-engaged position to allow the movement.

Once it is in a position where greater force is required (when the contact members 24 are beginning to engage with the wheels 101), the plate 55 acts as a walking lever and is able to utilize the mechanical advantage of the linkage assembly 20 to firmly wedge the linkage assembly 20 between the two wheels 101 and effectively preventing rotation in either wheel 101.

Prior art devices use a lead screw that requires rotation of a threaded member about a threaded rod. This structure does not allow for quick deployment. The adjustment is thus a very slow process, requiring many rotations of the lead screw, regardless of if the mechanical advantage provided by a lead screw is necessary or not.

The biasing members 63, 68 can include various structures that apply a biasing force. Examples include but are not limited to springs and various resilient materials.

The stabilizer 10 can be used on a variety of different multi-axle vehicles 100. One example includes recreational vehicles (RV) that include but are not limited to motorhomes, campervans, coaches, travel trailers, camper trailers, fifth-wheel trailers, popup campers, and truck campers. Another example is a multi-axle trailer, such as a trailer that is pulled by a large truck. Other examples include trailers configured to transport various items, such as a boat trailer and a landscaping trailer used to transport landscaping equipment and supplies.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A stabilizer to stabilize wheels on a multi-axle vehicle, the stabilizer comprising:
a working bar comprising opposing first and second ends and with a longitudinal axis that extends along a length;
a linkage assembly connected to the working bar and comprising arms that are pivotally connected together and movable between a retracted orientation with a first width measured perpendicular to the longitudinal axis and an extended orientation with a larger second width measured perpendicular to the longitudinal axis;
an actuator mounted to the working bar and to the linkage assembly, the actuator comprising:
a first plate with a first opening that receives the working bar;
a second plate with a second opening that receives the working bar;
the first plate and the second plate movable relative to each other between a first angular position to prevent movement of the actuator along the length of the working bar and secure the linkage assembly and a second angular position to provide for movement along the length of the working bar to move the linkage assembly between the retracted orientation and the extended orientation.

2. The stabilizer of claim 1, wherein the actuator further comprises a biasing member that biases the first plate and the second plate towards the first angular position to prevent movement of the actuator along the length of the working bar.

3. The stabilizer of claim 1, wherein the linkage assembly is fixedly connected to the working bar at a first point along the longitudinal axis with the first point being spaced away from the actuator.

4. The stabilizer of claim 3, wherein the linkage assembly is fixedly connected to the working bar at a single point.

5. The stabilizer of claim 1, wherein the linkage assembly comprises a first linkage positioned on a first side of the working bar and a second linkage positioned on an opposing second side of the working bar, the first and second linkages aligned in planes that are parallel.

6. The stabilizer of claim 1, further comprising cylindrical contact members mounted at the outer edges of the linkage assembly, the contact members configured to contact against the wheels of the multi-axle vehicle.

7. The stabilizer of claim 1, wherein the actuator further comprises:
a body with a handle;
a lever arm pivotally connected to the body;
the first plate mounted to the body away from the handle and the lever arm; and
the second plate mounted in the lever arm.

8. The stabilizer of claim 7, wherein the body comprises a body opening that is aligned with the first opening of the first plate and the second opening of the second plate, the working bar extending through the actuator at each of the opening, the first opening, and the second opening.

9. The stabilizer of claim 1, wherein the linkage assembly comprises a first end and a second end, the first end is fixedly connected to the working bar and the actuator is mounted to the second end.

10. A stabilizer to stabilize wheels on a multi-axle vehicle, the stabilizer comprising:
an elongated working bar;
a linkage assembly connected to the working bar and comprising arms that pivotally connect together and are movable between a retracted orientation and an extended orientation;
an actuator mounted to the working bar and to the linkage assembly and configured to move the linkage assembly between the retracted and extended orientations, the actuator comprising:
a body with a body opening;
a first plate mounted to the body and with a first plate that comprises a first plate opening;
a second plate mounted to the body and with a second plate that comprises a second plate opening;
the body opening, first plate opening, and second plate opening being aligned and with the working bar extending through each;
the first plate and the second plate movable relative to each other between a first angular position to prevent movement of the actuator along the working bar and secure the linkage assembly and a second angular position to provide for movement along the length of the working bar to move the linkage assembly between the retracted orientation and the extended orientation.

11. The stabilizer of claim 10, wherein the first plate and the second plate are aligning in a non-parallel arrangement in the first angular position and a parallel arrangement in the second angular position.

12. The stabilizer of claim 10, wherein the first plate and the second plate are each perpendicular to the working bar in the second angular position.

13. The stabilizer of claim 10, wherein the actuator further comprises a lever arm pivotally mounted to the body, and with one of the first plate and the second plate mounted to the lever arm.

14. The stabilizer of claim 10, wherein each of the first plate and the second plate are movable relative to the body.

15. The stabilizer of claim 10, wherein the first plate is spaced apart from the second plate along the working bar.

16. A method of stabilizing wheels of a multi-axle vehicle, the method comprising:
positioning a stabilizer that is in a retracted orientation in a space formed between the wheels of the multi-axle vehicle;
orienting the stabilizer in the space with a working bar aligned vertically in the space and with contact members facing towards the wheels;
applying a force to an actuator on the working bar and positioning plates in the actuator at a first angular orientation;
with the plates in the first angular orientation, sliding the actuator along the working bar and causing the contact members to move outward from the working bar and contact against the wheels; and
with the contact members contacting against the wheels, releasing the force from the actuator and thereby positioning the plates in the handle at a second angular orientation and preventing the contact members from moving out of contact with the wheels.

17. The method of claim 16, further comprising sliding the actuator along the working bar and expanding a width of a linkage assembly by sliding a bottom of a linkage assembly that is connected to the actuator towards a top of the linkage assembly that is fixedly connected to the working bar.

18. The method of claim 16, further comprising contacting four of the contact members against the wheels with a first pair of the contact members mounted to a first pair of arms and a second pair of the contact members mounted to a second pair of the arms.

19. The method of claim 16, further comprising maintaining a bottom of the working bar above a ground surface that supports the wheels while sliding the actuator along the working bar.

20. The method of claim 16, further comprising sliding the actuator along the working bar without rotating the actuator or the working bar.
